(19) United States
(12) Patent Application Publication
(10) Pub. No.: US 2018/0370451 A1
(43) Pub. Date: Dec. 27, 2018

(54) Tilt Hauling Frame For Precast Panels

(71) Applicant: Illini Precast, LLC, Westchester, WI (US)

(72) Inventors: Craig Wagenbach, Chicago, IL (US); Scott Alecci, Oak Park, IL (US)

(21) Appl. No.: 16/014,970

(22) Filed: Jun. 21, 2018

Related U.S. Application Data
(60) Provisional application No. 62/523,138, filed on Jun. 21, 2017.

(51) Int. Cl. B60R 9/06; B60P 3/00; B65G 67/04; B65G 67/24

(52) U.S. Cl. CPC B60R 9/06; B60P 3/00; B65G 67/04; B65G 2201/0223; B65G 2201/022; B65G 2201/0217; B65G 67/24

(57) ABSTRACT

A tilt hauling frame comprising a base assembly configured to mount onto a trailer bed, a column assembly supported by the base assembly at a first end of the column assembly, and a panel arm assembly pivotally coupled proximate to a second end of the column assembly.

### CROSS-REFERENCE TO RELATED APPLICATIONS

This application claims priority to U.S. Provisional Patent Application No. 62/523,138, filed Jun. 21, 2017, the contents of which are hereby incorporated by reference in their entirety.

### BACKGROUND

The present disclosure relates to systems for transporting precast panels, and more particularly to a tilt hauling frame for precast panels.

Precast panels, such as precast concrete wall panels, are used to build various structures. Precast panels can be produced at any time of year in a controlled environment, which reduces their cost and makes it easier to control their quality. Production of precast panels also can begin as soon as or even before final designs of a building structure are completed, thereby saving valuable time. Once precast panels arrive at a job site, they can be erected quickly in most kinds of weather. By minimizing the need for site-specific poured concrete, for example, precast panels make it possible to build durable structures quickly, efficiently, and safely.

### SUMMARY

In one embodiment, the disclosure provides a tilt hauling frame comprising a base assembly configured to mount onto a trailer bed, a column assembly supported by the base assembly at a first end of the column assembly, and a panel arm assembly pivotally coupled proximate to a second end of the column assembly.

In another embodiment, the disclosure provides a tilt hauling frame comprising a base assembly, a column assembly rotationally coupled to the base assembly about a rotational axis co-axial with a longitudinal axis of the column assembly, and a panel arm assembly pivotally coupled to the column assembly about a pivot axis oriented perpendicular to the longitudinal axis of the column assembly.

In another embodiment, the disclosure provides a tilt hauling frame comprising a base assembly, a column assembly, a hinge joint, and a panel arm assembly. The base assembly includes a lower base subassembly configured to mount onto a trailer bed, a first sleeve attached perpendicularly to the lower base subassembly, a second sleeve disposed co-axially with the first sleeve above the first sleeve relative to the lower base subassembly, and a plurality of support arms connected between the second sleeve and lower base subassembly. The column assembly is supported by the base assembly and includes a column member having a lower end received in the first sleeve, an upper end opposite the lower end, and an intermediate portion disposed between the upper end and the lower end and received in the second sleeve. The hinge joint is attached to the upper end of the column member, the hinge joint having a pivot axis perpendicular to a longitudinal axis of the column member. The panel arm assembly is pivotally coupled to the column assembly via the hinge joint and configured to support a load in a transport position when the panel arm assembly is oriented in a direction across a width of the trailer bed and is tilted relative to the trailer bed into contact with the base assembly.

Other aspects of the invention will become apparent by consideration of the detailed description and accompanying drawings.

### BRIEF DESCRIPTION OF THE DRAWINGS

FIG. 1 is a front view of a tilt hauling frame including a base assembly, a column assembly and a panel arm assembly.

FIG. 1A is partially exploded view of the tilt hauling frame of FIG. 1.

FIG. 1B is an enlarged detail view of a portion of the panel arm assembly of FIG. 1, including a foot subassembly.

FIG. 1C is an enlarged partial breakaway view of a portion of the base assembly of FIG. 1, including a spring loaded mechanism.

FIG. 2 is a right side view of the tilt hauling frame of FIG. 1.

FIG. 2A is partially exploded view of the tilt hauling frame of FIG. 2.

FIG. 3 is a front view of the base assembly of FIG. 1.

FIG. 4 is a right side view of the base assembly of FIG. 1.

FIG. 5 is a top view of the base assembly of FIG. 1.

FIG. 5A is an enlarged detail view of a portion of the base assembly of FIG. 5, including a sliding hook subassembly.

FIG. 5B is an enlarged detail view of a portion of the base assembly of FIG. 5, including a lever connected to a hinge joint.

FIG. 6 is a front view of the column assembly of FIG. 1.

FIG. 7 is a left side view of the column assembly of FIG. 1.

FIG. 8 is a top view of the column assembly of FIG. 1.

FIG. 9 is a front view of the panel arm assembly of FIG. 1.

FIG. 10 is a top view of the panel arm assembly of FIG. 1.

FIG. 11 is a bottom view of the panel arm assembly of FIG. 1.

FIG. 12 is a right side view of the panel arm assembly of FIG. 1.

FIG. 13 is a front view of the foot subassembly of the panel arm assembly of FIG. 1.

FIG. 14 is a right side view of the foot subassembly of FIG. 13.

FIG. 15 is a bottom view of the foot subassembly of FIG. 13.

FIG. 16 is a front view of the tilt hauling frame of FIG. 1 mounted on a flatbed trailer showing the panel arm assembly in a loading position.

FIG. 17 is a front view of the tilt hauling frame of FIG. 1 mounted on a flatbed trailer showing the panel arm assembly in an alternative loading position using a jack.

FIG. 17A is a top view taken through plan 17A-17A of FIG. 17.

FIG. 17B is an elevation view taken through elevation 17B-17B of FIG. 17A.

FIG. 18 is a front view of the tilt hauling frame of FIG. 1 mounted on a flatbed trailer showing a precast panel loaded for transport using a column spacer.

FIG. 19 is a front view of another tilt hauling frame mounted on a flatbed trailer showing a precast panel loaded for transport without a column spacer.

FIG. 20 is a front view of another tilt hauling frame including a base assembly, a column assembly, a panel arm assembly and a hydraulic cylinder.

FIG. 20A is partially exploded view of the tilt hauling frame of FIG. 20.

FIG. 21 is a top view of the tilt hauling frame of FIG. 20.

FIG. 22 is an enlarged right side view of the tilt hauling frame of FIG. 20.

FIG. 23 is a front view of the base assembly of FIG. 20.

FIG. 24 is a top view of the base assembly of FIG. 20.

FIG. 25 is a right side view of the base assembly of FIG. 20.

FIG. 26 is a front view of the panel arm assembly of FIG. 20.

FIG. 27 is a top view of the panel arm assembly of FIG. 20.

FIG. 28 is a right side view of the panel arm assembly of FIG. 20.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

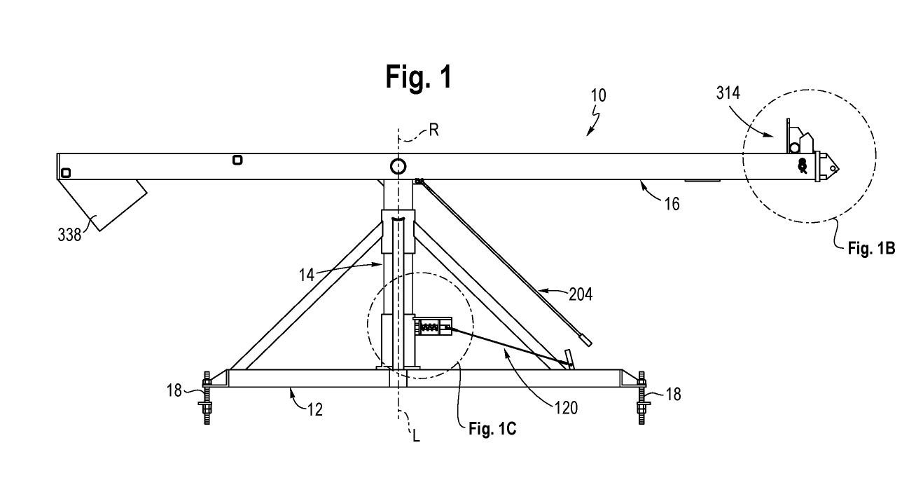

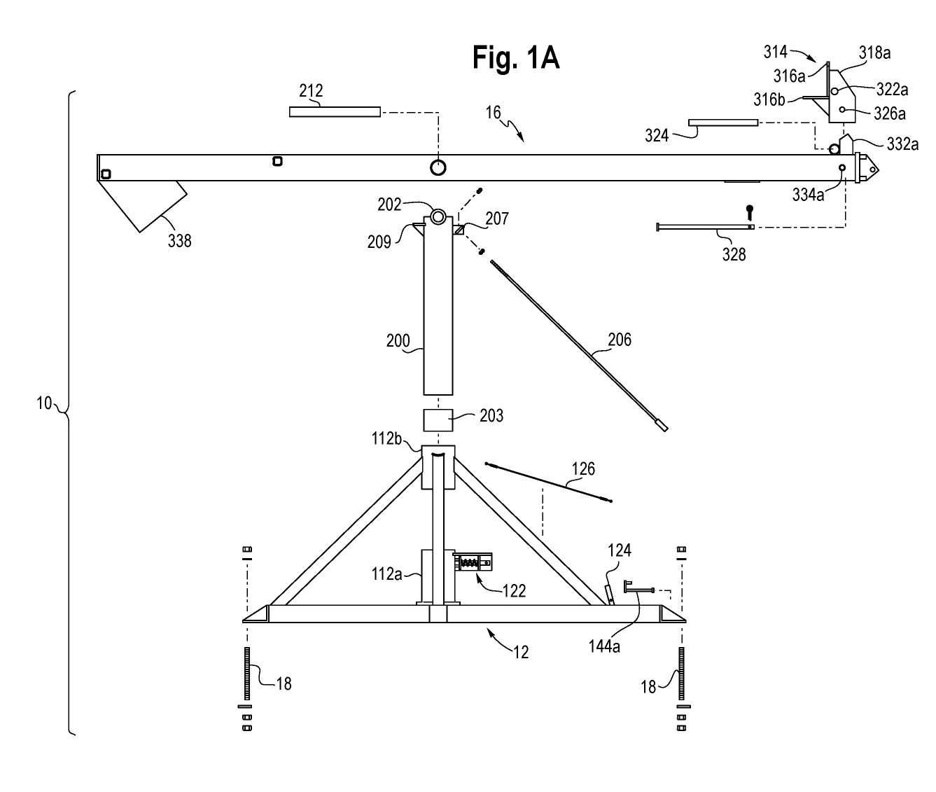

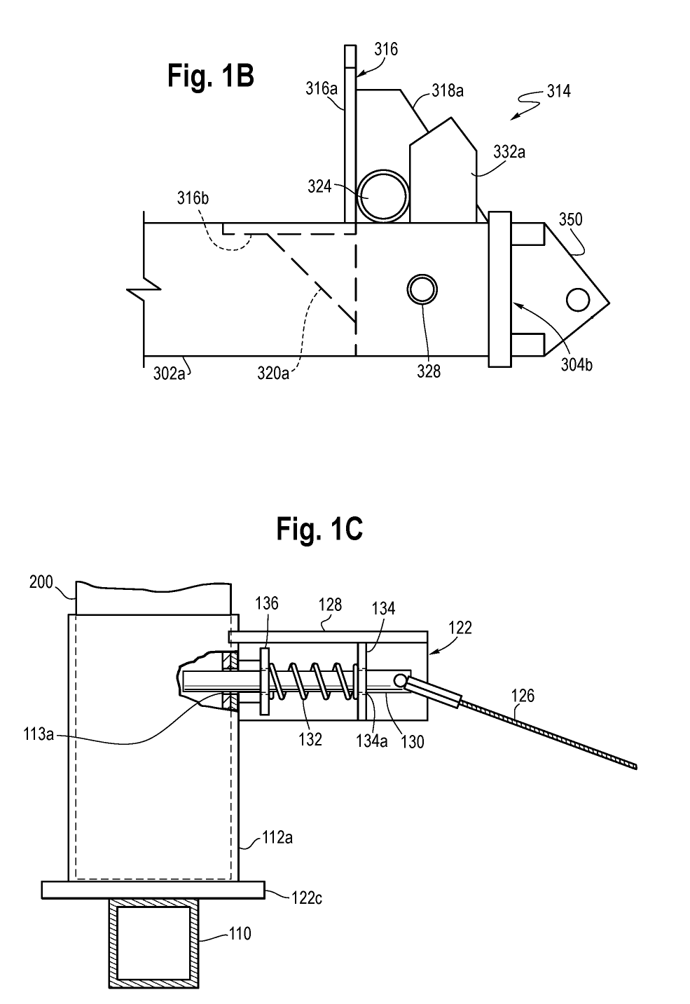

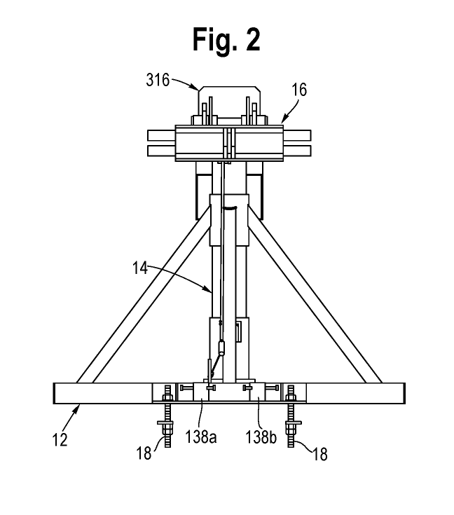

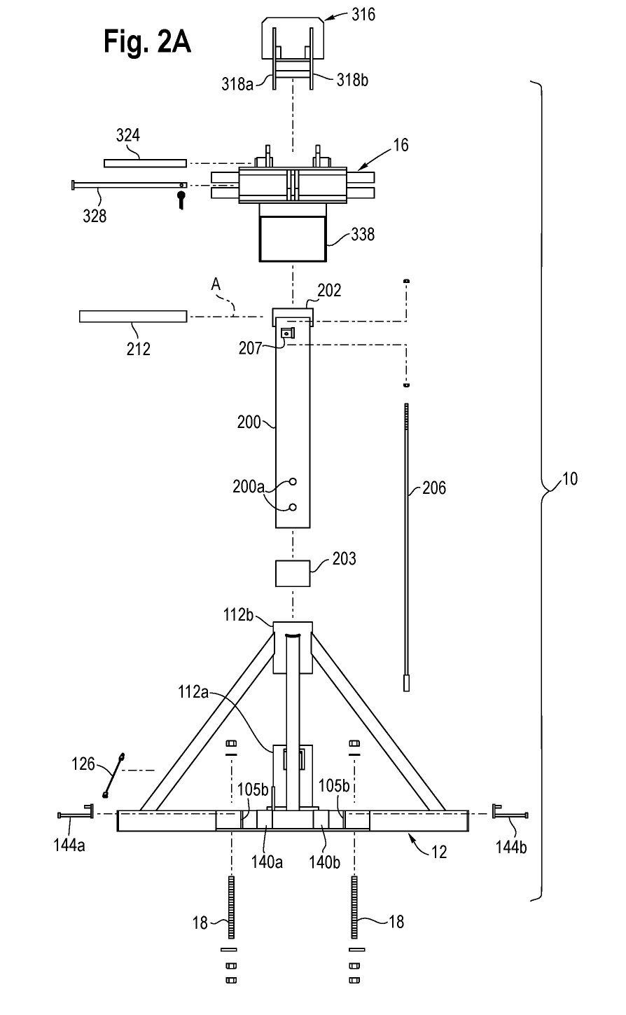

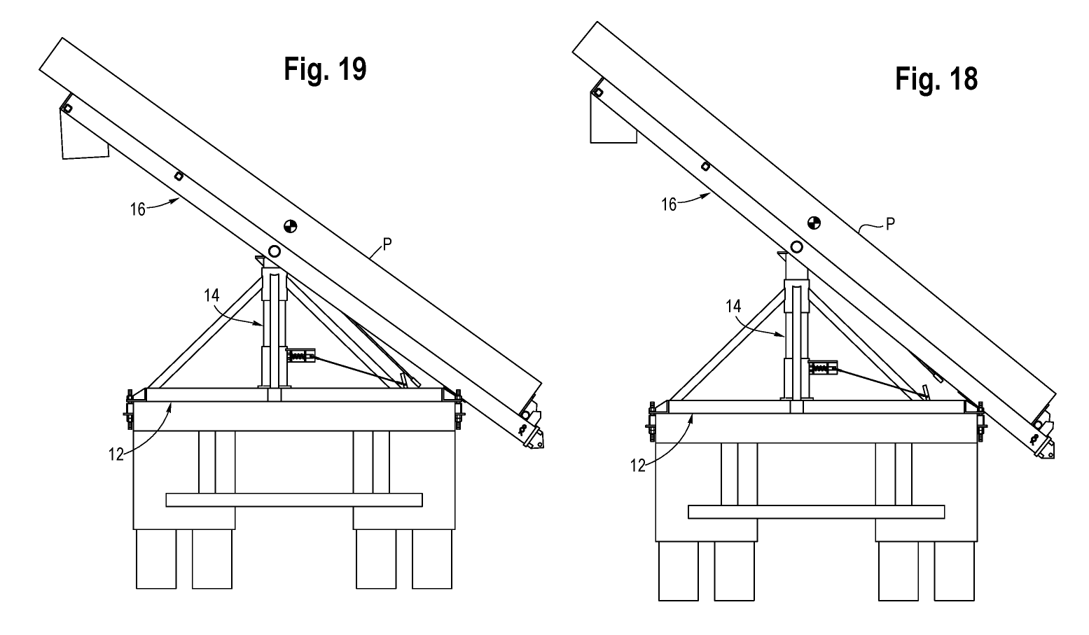

FIGS. 1-1a and 2-2a illustrate a tilt hauling frame 10 comprising a base assembly 12, a column assembly 14 and a panel arm assembly 16. The column assembly 14 is rotationally coupled to the base assembly 12 about a rotational axis R. The rotational axis R may be oriented substantially parallel to a longitudinal axis L of a column member 200 of the column assembly 14. More specifically, the rotational axis R may be co-axial with the longitudinal axis L of the column member 200 of the column assembly 14. The panel arm assembly 16 is pivotally coupled to the column assembly 14 about a pivot axis A. The pivot axis A may be oriented perpendicular to the longitudinal axis L of the column member 200 of the column assembly 14. As further described below, one or more tilt hauling frames 10 may be mounted on a transport vehicle, for example a flatbed semitrailer, for hauling a precast panel P that is supported by the respective panel arm assemblies 16 of the tilt hauling frames 10 (FIGS. 18-19). For example, a pair of tilt hauling frames 10 may be mounted on a flatbed trailer for hauling a precast panel P that is supported at opposite ends thereof by the respective panel arm assemblies 16 of the pair of tilt hauling frames 10.

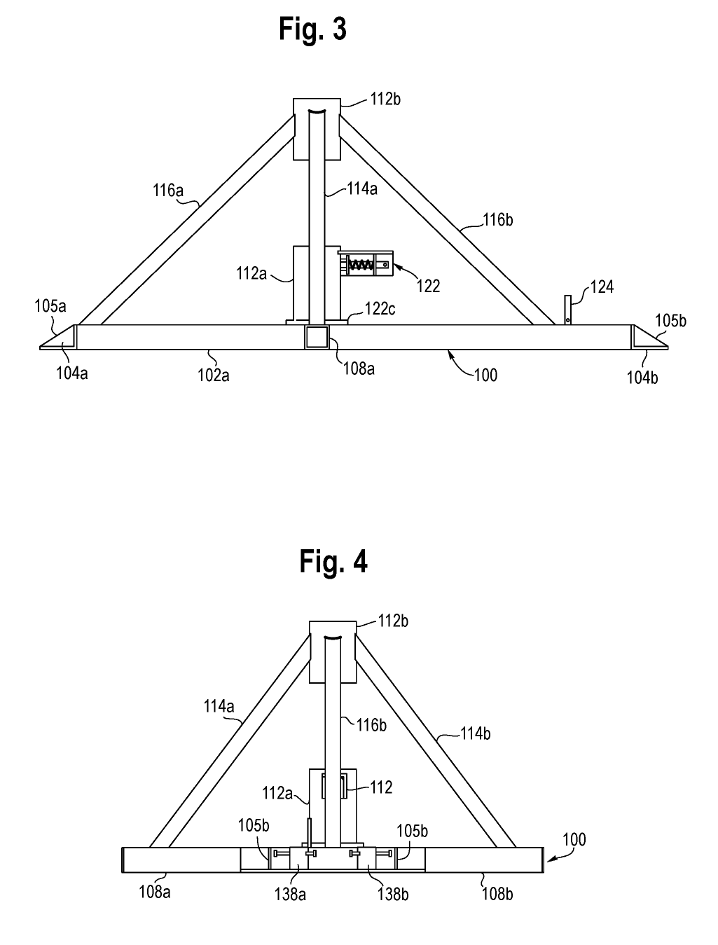

With reference to FIGS. 3-5, the base assembly 12 may include a lower base subassembly 100 having a pair of generally parallel, spaced-apart oppositely facing side members 102a and 102b connected between a pair of spaced-apart oppositely facing transverse end members 104a and 104b. The side members 102a and 102b may be steel tubing, for example, ASTM cold-formed carbon steel tube in a square or rectangular shape. However, it is also contemplated that other steel shapes, including, but not limited to, channels and wide flange beams, and/or other alloys or materials of adequate strength may be used. The end members 104a and 104b may be L-shaped brackets, for example, ASTM structural steel angles, each having a base leg or plate that is attached to the side members 102a and 102b and a perpendicular mounting leg or plate that defines mounting holes 106 for passing anchor bolts 18 (FIGS. 1-1a and 2-2a) through the mounting leg and into or through the stake pockets of a flatbed trailer to secure the base assembly 12 to the flatbed trailer. The end members 104a and 104b may also include one or more reinforcement ribs 105a and 105b, respectively, connected between the base leg and the mounting leg of the L-shaped bracket to increase the strength and rigidity of the end members 104a and 104b.

In the illustrated embodiment, each anchor bolt 18 comprises a threaded rod and hex nut assembly. However, it is contemplated that other suitable attachment devices and methods, such as screws, may be used to secure the base assembly 12 to a flatbed trailer or other transport vehicle. Also, each illustrated end member 104a and 104b defines an inner pair of mounting holes 106 configured to accommodate a pair of stake pockets on a standard 96″ wide trailer and an outer pair of mounting holes 106 configured to accommodate a pair of stake pockets on a standard 102″ wide trailer. However, it also contemplated that each end member 104a and 104b may define fewer or more mounting holes 106 to accommodate trailers having different configurations, including different widths and stake pocket spacing.

The lower base subassembly 100 also may include a pair of outer transverse bracing members 108a and 108b and an inner transverse bracing member 110 that are co-planar with the side members 102a and 102b. The outer transverse bracing members 108a and 108b and the inner transverse bracing member 110 may be steel tubing, for example, ASTM cold-formed carbon steel tube in a square or rectangular shape. However, it is also contemplated that other steel shapes, including, but not limited to, channels and wide flange beams, and/or other alloys or materials of adequate strength may be used. In the illustrated embodiment, the first outer transverse bracing member 108a is attached perpendicularly at one end thereof to the first side member 102a and extends longitudinally away from the side members 102a and 102b. The second outer transverse bracing member 108b is attached perpendicularly at one end thereof to the second side member 102b and extends longitudinally away from the side members 102a and 102b. The inner transverse bracing member 110 is connected between the side members 102a and 102b. The outer transverse bracing members 108a and 108b and the inner transverse bracing member 110 are shown aligned co-axially with each other and off-center relative to the center length of the side members 102a and 102b. More specifically, when viewed along a reference axis parallel to the side members 102a and 102b, the outer transverse bracing members 108a and 108b and the inner transverse bracing member 110 may be located between the first end member 104a and the midpoint of the side members 102a and 102b.

In addition, the base assembly 12 may include a sleeve subassembly 112 having a pair of sleeves 112a and 112b for supporting the column assembly 14 as described further below. The sleeves 112a and 112b may be steel tubing, for example, ASTM cold-formed carbon steel tube in a round shape. However, it is also contemplated that other alloys or materials of adequate strength may be used. The lower sleeve 112a may be attached perpendicularly at one end thereof to the inner transverse bracing member 110 via a mounting plate 112c at about the midpoint of the length of the inner transverse bracing member 110. The longitudinal axis of the illustrated lower sleeve 112a is oriented perpendicularly to a plane containing the side members 102a and 102b of the lower base subassembly 100 and is generally aligned with or co-axial with the rotational axis R of the column assembly 14. The upper sleeve 112b may be vertically aligned or centered above the lower sleeve 112a relative to the lower base subassembly 100. More specifically, the longitudinal axis of the illustrated upper sleeve 112b also is oriented perpendicularly to a plane containing the side members 102a and 102b of the lower base subassembly 100 and is generally aligned with or co-axial with the rotational axis R of the column assembly 14. The upper sleeve 112b may be supported by support arms attached to the lower base subassembly 100 as described further below.

In particular, the base assembly 12 may include a pair of lateral support arms 114a and 114b and a pair of central support arms 116a and 116b. The lateral support arms 114a and 114b and the central support arms 116a and 116b may be steel tubing, for example, ASTM cold-formed carbon steel tube in a square or rectangular shape. However, it is also contemplated that other steel shapes, including, but not limited to, channels and wide flange beams, and/or other alloys or materials of adequate strength may be used.

In the illustrated embodiment, the first lateral support arm 114a is connected between the first outer transverse bracing member 108a and the upper sleeve 112b and the second lateral support arm 114b is connected between the second outer transverse bracing member 108b and the upper sleeve 112b. More specifically, the illustrated first lateral support arm 114a extends obliquely upwardly toward the upper sleeve 112b from an end portion of the first outer transverse bracing member 108a and is co-planar with the first outer transverse bracing member 108a. Similarly, the illustrated second lateral support arm 114b extends obliquely upwardly toward the upper sleeve 112b from an end portion of the second outer transverse bracing member 108b and is co-planar with the second outer transverse bracing member 108b.

Also, the first central support arm 116a is connected between the first end member 104a and the upper sleeve 112b. More specifically, the illustrated first central support arm 116a extends obliquely upwardly toward the upper sleeve 112b from about the midpoint of the base leg or plate of the first end member 104a and is oriented parallel with the side members 102a and 102b of the lower base subassembly 100. The second central support arm 116b is connected between a central bracket 118 and the upper sleeve 112b. The central bracket 118 may be a L-shaped bracket, for example, an ASTM structural steel angle having a base leg or plate and a perpendicular support leg or plate. The central bracket 118 may include one or more reinforcement ribs connected between the base leg and the support leg of the L-shaped bracket to increase the strength and rigidity of the central bracket 118. In the illustrated embodiment, the central bracket 118 is connected between the side members 102a and 102b at a location between the second end member 104b and inner transverse bracing member 110. The illustrated second central support arm 116b extends obliquely upwardly toward the upper sleeve 112b from about the midpoint of the base leg or plate of the central bracket 118 and is oriented parallel with the side members 102a and 102b of the lower base subassembly 100.

The base assembly 12 may also include a column locking subassembly 120 configured to releasably lock the column assembly 14 against rotation relative to the base assembly 12. In the illustrated embodiment, the column locking subassembly 120 includes a spring loaded mechanism 122 operatively coupled to a lever 124 via a cable 126 (FIGS. 1-1A).

With reference to FIG. 1C, the illustrated spring loaded mechanism 122 includes a housing 128, a column locking pin 130, a compression spring 132, a retaining member 134, and a collar 136. The housing 128 may be a bracket, for example, an ASTM structural steel angle. The retaining member 134 may be a steel plate affixed transversely within the housing 128 proximal a first end of the housing 128 and defining a pass-through hole 134a for the column locking pin 130. In the illustrated embodiment, the housing 128 is perpendicularly attached at a second end thereof opposite the first end to a wall of the lower sleeve 112a. In particular, the housing 128 is oriented so that the pass-through hole 134a of the retaining member 134 is co-axial with a wall opening 113a provided in the wall of the lower sleeve 112a for the column locking pin 130. A distal end portion of the column locking pin 130 is slidably received in the pass-through hole 134a of the retaining member 134 and a proximal end portion of the column locking pin 130 is slidably received in the wall opening 113a of the lower sleeve 112a. The collar 136 is secured to the locking pin between the lower sleeve 112a and the retaining member 134. The compression spring 132 is positioned over the column locking pin 130 between the collar 136 and the retaining member 134. In a substantially unloaded state, the compression spring 132 biases the column locking pin 130, which extends through the pass-through hole 134a of the retaining member 134 and the wall opening 113a of the lower sleeve 112a, into engagement with a portion of the column member 200 of column assembly 14 received in the lower sleeve 112a (as further described below), thereby locking the column assembly 14 against rotation about the rotational axis R relative to the base assembly 12. The collar 136 may be a nut locking member having a nut threaded onto a threaded surface of the locking pin and a steel plate washer interposed between the nut and the compression spring 132. This arrangement allows the position of the collar 136 on the column locking pin 130 to be adjusted by rotating the nut to regulate travel of the column locking pin 130.

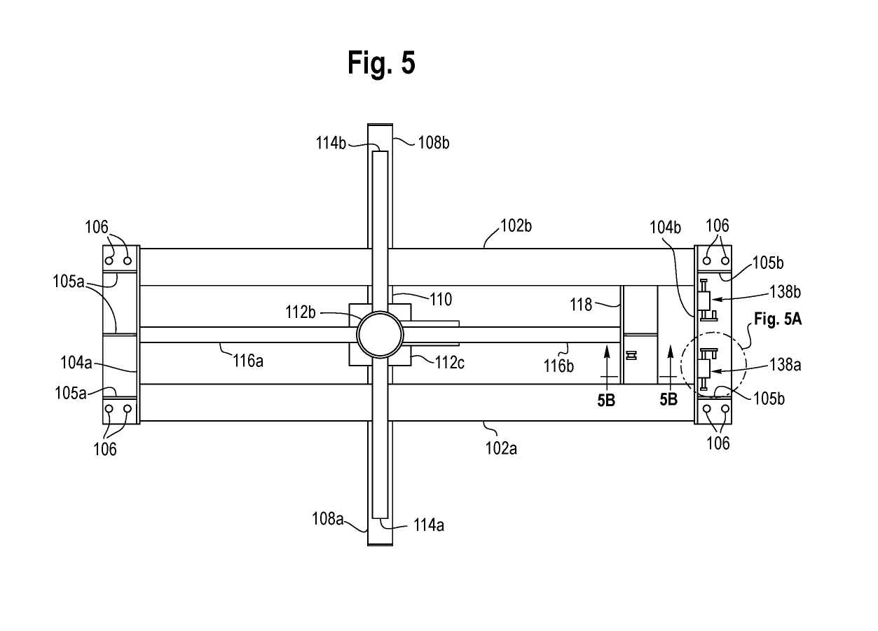

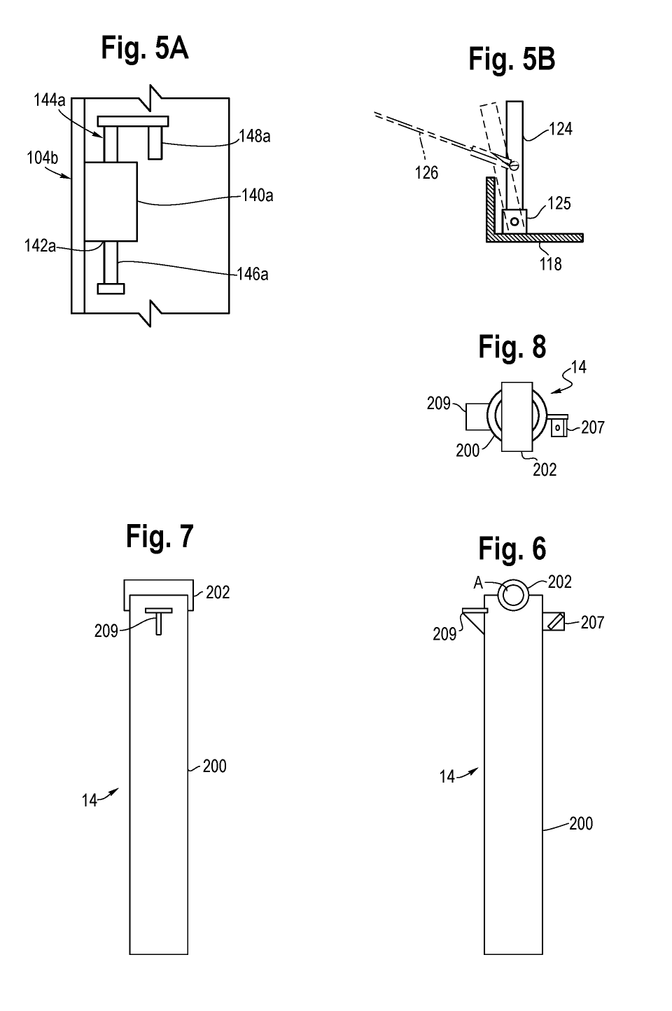

With reference to FIGS. 5 and 5B, the lever 124 may be pivotally coupled to the central bracket 118 for movement between a locked position and an unlocked position. The illustrated lever 124 is pivotally coupled at one end thereof to the perpendicular support leg of the L-shaped central bracket 118 via a hinge joint 125 having an axis of rotation perpendicular to the longitudinal axis of column locking pin 130. The lever 124 may be coupled, for example at about its midpoint, to the distal end of the locking pin via the cable 126. The lever 124 and the cable 126 are configured so that when the lever 124 is in the locked position, as shown in FIGS. 1 and 1a, the compression spring 132 is in a substantially unloaded state and the column locking pin 130 is biased into engagement with the column member 200 of column assembly 14. When the lever 124 pivots away from spring loaded mechanism 122 to an unlocked position, the cable 126 pulls the column locking pin 130 out of engagement with the column member 200 and the collar 136, which is secured to the column locking pin 130, compresses the compression spring 132. When the lever 124 pivots back to its locked position, the compression spring 132 biases the column locking pin 130 via the collar 136 back into engagement with the column member 200.

In the illustrated embodiment, the base assembly 12 further includes a pair of sliding hook subassemblies 138a and 138b as shown in FIGS. 2-2A and 4-5A. The first sliding hook subassembly 138a includes a mounting block 140a attached inside the second end member 104b between the midpoint of the second end member 104b and the end of the second end member 104b connected to the first side member 102a. The mounting block 140a defines a through opening 142a that extends through the mounting block 140a having an axis oriented generally parallel to the second end member 104b. The first sliding hook subassembly 138a further includes a hook member 144a having a body portion 146a and a hook portion 148a at the end of the body portion 146a proximal the midpoint of the second end member 104b. The body portion 146a is slidably received in the opening 142a of the mounting block 140a. The second sliding hook subassembly 138b is similarly constructed, including a mounting block 140b attached inside the second end member 104b between the midpoint of the second end member 104b and the end of the second end member 104b connected to the second side member 102b. The mounting block 140b also defines a through opening 142b that extends through the mounting block 140b having an axis oriented generally parallel to the second end member 104b. The second sliding hook subassembly 138b further includes a hook member 144b having a body portion 146b and a hook portion 148b at the end of the body portion 146b proximal the midpoint of the second end member 104b. The body portion 146b is slidably received in the opening 142b of the mounting block 140b. As further described below, the hook members 144a and 144b can slide in and out of engagement with the panel arm assembly 16 for loading the panel arm assembly 16 with a precast panel P.

With reference to FIGS. 6-8, the column assembly 14 includes a column member 200 and a tubular hinge joint 202. The column member 200 and the tubular hinge joint 202 may be steel pipe, for example, ASTM seamless and welded, black and hot-dipped, galvanized steel pipe. The tubular hinge joint 202 may be attached or mounted proximate an upper end of the column member 200 so as to pivot about the pivot axis A perpendicular to the longitudinal axis L of the column member 200. In the illustrated embodiment, the tubular hinge joint 202 is attached to the upper end of the column member 200. As shown in FIGS. 1-1A and 2-2A, the lower end of the column member 200 opposite the upper end is rotatably received in the lower sleeve 112a and is supported by the mounting plate 112c. An intermediate portion of the column member 200 between the upper end and the lower end of the column member 200 is rotatably received in the upper sleeve 112b. In order to allow the column locking subassembly 120 to lock the column assembly 14 against rotation relative to the base assembly 12, a lower portion of the illustrated column member 200 proximal its lower end defines an opening 200a in the wall of the column member 200 configured to engage the spring biased column locking pin 130 when the lever 124 is in its locked position. The opening 200a may be located so as to receive the column locking pin 130 therein when the pivot axis A of the tubular hinge joint 202 is oriented in a direction generally perpendicular to the side members 102a and 102b. It is also contemplated that a plurality of openings 200a may be formed in the column member 200 to accommodate use of a column spacer 203. The column spacer 203 may be disposed in the lower sleeve 112a between the mounting plate 112c and the column member 200 for adjusting the height of the column assembly 14.

The column assembly 14 may also include a column rotator subassembly 204 having a rod 206 that is connected via a coupling 207 to the column member 200 as shown in FIGS. 1-1A and 2-2A. In the illustrated embodiment, the coupling 207 is attached to the column member 200 proximal the upper end of the column member 200. The rod 206 has an externally threaded end portion configured to screw into a threaded opening of the coupling 207. The coupling 207 is configured so that the rod 206 extends away from coupling 207 toward the lower base subassembly 100 in a direction oblique to the longitudinal axis L of a column member 200. When the lever 124 is in its unlocked position and the column locking pin 130 is disengaged with the column member 200, rotating the rod 206 about the longitudinal axis L of a column member 200 will cause the column assembly 14 to rotate relative to the base assembly 12.

In addition, the column assembly 14 may include a flange 209 attached to the column member 200 proximal the upper end of the column member 200 to limit rotation of an unloaded panel arm assembly 16 as further described below. In the illustrated embodiment, the flange 209 is generally centered about the center length of the tubular hinge joint 202.

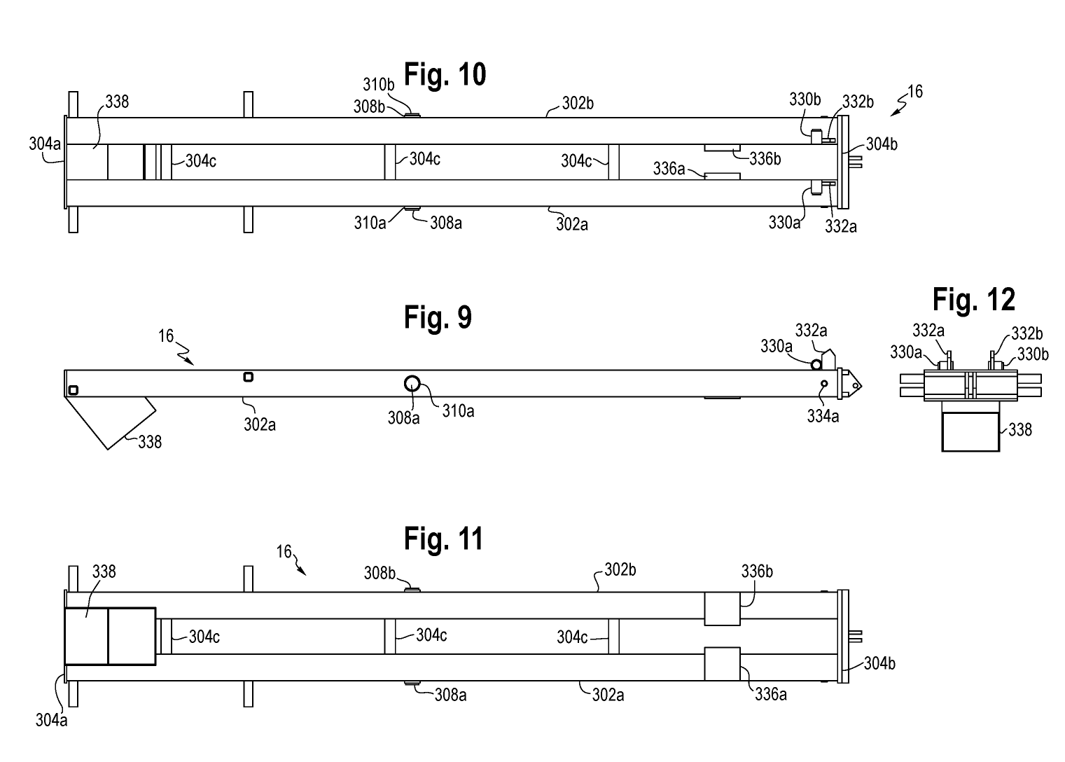

With reference to FIGS. 9-12, the panel arm assembly 16 may include a pair of generally parallel, spaced-apart oppositely facing support beams 302a and 302b connected between a pair of spaced-apart oppositely facing transverse rear and forward end cross members 304a and 304b. The support beams 302a and 302b may be steel tubing, for example, ASTM cold-formed carbon steel tube in a square or rectangular shape. However, it is also contemplated that other steel shapes, including, but not limited to, channels and wide flange beams, and/or other alloys or materials of adequate strength may be used. The rear and forward end cross members 304a and 304b may be steel plates. The illustrated panel arm assembly 16 also includes one or more intermediate cross members 304c perpendicularly connected between the support beams 302a and 302b and disposed at spaced-apart locations between the rear and forward end cross members 304a and 304b to increase the rigidity of the panel arm assembly 16. The intermediate cross members 304c may steel pipe, for example, ASTM seamless and welded, black and hot-dipped, galvanized steel pipe. In addition, the panel arm assembly 16 may include a counterweight 338 attached to the rear end portions of the support beams 302a and 302b proximal the rear end cross member 304a.

Each support beam 302a and 302b defines a pivot opening 308a and 308b that extends through the support beam perpendicularly to the longitudinal axis of the support beam. In the illustrated embodiment, the pivot openings 308a and 308b are axially aligned and are formed off-center relative to the center length of the support beams 302a and 302b. More specifically, each pivot opening 308a and 308b may be located between the rear end cross member 304a and the midpoint of the corresponding support beams 302a and 302b. A bushing 310a and 310b is securely mounted in each of the pivot openings 308a and 308b. The tubular hinge joint 202 at the upper end of the column member 200 is received between the support beams 302a and 302b and is axially aligned with the pivot openings 308a and 308b. As shown in FIGS. 1-1A and 2-2A, an arm linchpin 212 extends through the hinge joint 202 and the bushings 310a and 310b in the pivot openings 308a and 308b so as to pivotally couple the panel arm assembly 16 to the column assembly 14 off-center along the length of the panel arm assembly, thereby allowing the panel arm assembly 16 to rotate between different positions for loading and transporting a precast panel P.

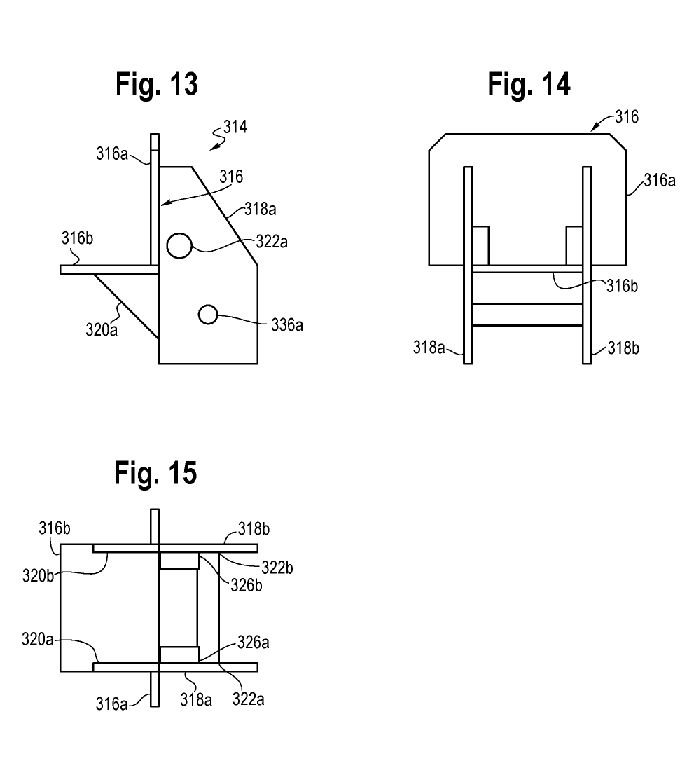

With reference to FIGS. 1-1B and 2-2A, the panel arm assembly 16 may be operably coupled to a foot subassembly 314 proximal the forward end cross member 304b. As further shown in FIGS. 13-15, the illustrated foot subassembly 314 includes an L-shaped bracket 316 having a base steel plate 316a and a perpendicular support steel plate 316b. An upper portion of each of a pair of parallel hinge plates 318a and 318b is attached transversely to the outer surface of the base steel plate 316a. A first reinforcement plate 320a is connected transversely between a lower portion of the first hinge plate 318a and the outer surface of the perpendicular support steel plate 316b. Similarly, a second reinforcement plate 320b is connected transversely between a lower portion of the second hinge plate 318b and the outer surface of the perpendicular support steel plate 316b.

In the illustrated embodiment, the hinge plates 318a and 318b are similarly constructed. More specifically, the first hinge plate 318a defines a foot linchpin opening 322a for receiving a foot linchpin 324 therethrough and a foot lock pin opening 326a for receiving a foot lock pin 328 therethrough. The second hinge plate 318b likewise defines a foot linchpin opening 322b for receiving the foot linchpin 324 therethrough and a foot lock pin opening 326b for receiving the foot lock pin 328 therethrough. The foot linchpin openings 322a and 322b are co-axial with each other and the foot lock pin openings 326a and 326b are co-axial with each other.

The foot subassembly 314 may be rotatably mounted to the support beams 302a and 302b via bearing members 330a and 330b. The bearing members 330a and 330b may be steel pipe, for example, ASTM seamless and welded, black and hot-dipped, galvanized steel pipe, attached on the support beams 302a and 302b proximal the forward end cross member 304b. The foot subassembly 314 is disposed between the support beams 302a and 302b so that the linchpin openings 322a and 322b are co-axial with the bearing members 330a and 330b. The foot linchpin 324 is inserted through the foot linchpin opening 322a and 322b and the bearing members 330a and 330b so as to pivotally couple the foot subassembly 314 to the support beams 302a and 302b, thereby allowing rotation of the foot subassembly 314 about the axis of the foot linchpin 324. In addition, stop members 332a and 332b may be attached on support beams 302a and 302b, respectively, between the bearing members 330a and 330b and the forward end cross member 304b. The illustrated stop members 332a and 332b are steel plates configured to prevent further rotation of the foot subassembly 314 once the base steel plate 316a of the L-shaped bracket 316 rotates into engagement with the stop members.

The foot subassembly 314 also may be locked against rotation using the foot lock pin 328. In the illustrated embodiment, each support beam 302a and 302b defines a foot lock pin through hole 334a and 334b that is aligned co-axially with the foot lock pin openings 326a and 326b of the hinge plates 318a and 318b when the foot subassembly 314 is pivotally coupled to the support beams 302a and 302b and the base steel plate 316a of the L-shaped bracket 316 is oriented perpendicularly to the support beams 302a and 302b. In this manner, the foot lock pin 328 may inserted through the foot lock pin through holes 334a and 334b and the foot lock pin openings 326a and 326b so as to prevent rotation of the foot subassembly 314.

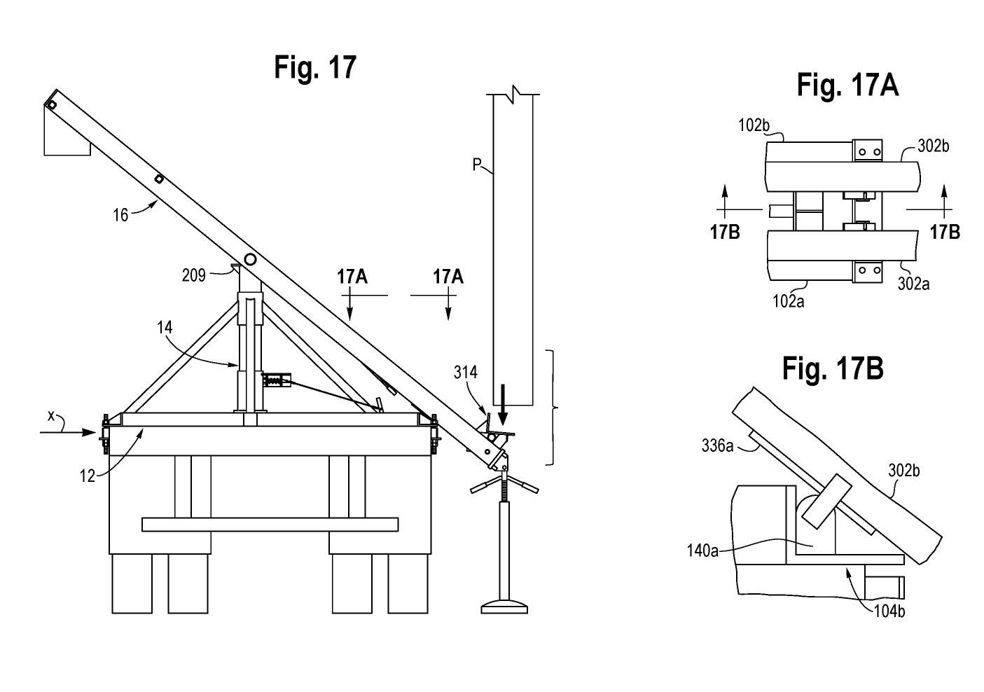

With reference to FIGS. 9-12, the panel arm assembly 16 also may include a pair of aligned protrusions 336a and 336b extending inwardly from the support beam 302a and 302b. The inwardly facing protrusions 336a and 336b may be steel plates attached to a lower surface of the support beams 302a and 302b proximal the forward end cross member 304b. The protrusions 336a and 336b are configured so that when the panel arm assembly 16 is loaded with a precast panel P and the panel arm assembly 16 pivots into contact with the mounting blocks 140a and 140b of the sliding hook subassemblies 138a and 138b, the hook members 144a and 144b of the sliding hook subassemblies 138a and 138b can slide into engagement with the protrusions 336a and 336b to prevent undesired rotation of the panel arm assembly 16 (FIGS. 17A-17B).

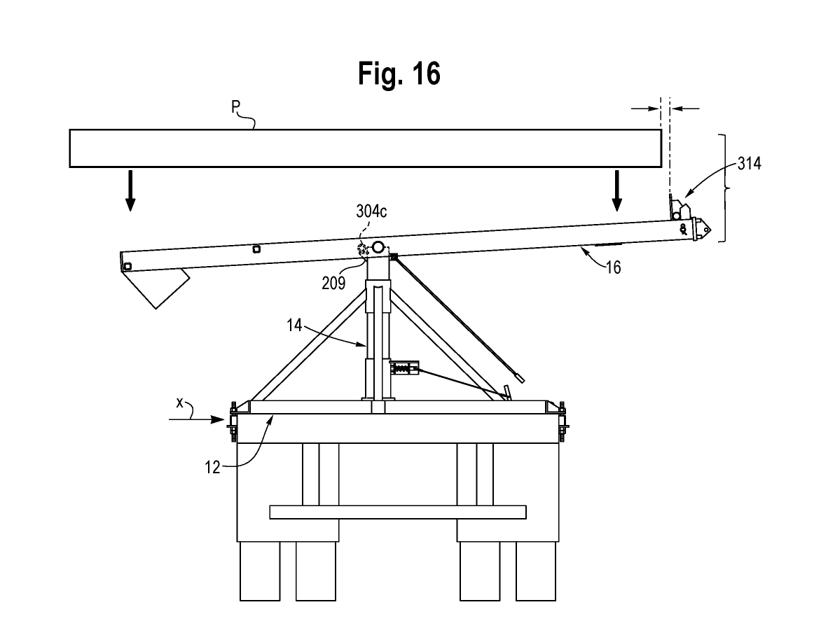

The precast panel P may be loaded in either a horizontal or vertical orientation. With reference to FIG. 16, the tilt hauling frame 10 may be secured to a flatbed trailer and configured for loading a precast panel P in a horizontal position relative to the flatbed trailer as shown. More specifically, in the illustrated embodiment, the lever 124 is in its locked position so that the column assembly 14 is locked against rotation about the rotational axis R relative to the base assembly 12. The unloaded panel arm assembly 16 is oriented generally parallel with the side members 102a and 102b of the lower base subassembly 100 in a direction across the width of the flatbed trailer, and the pivot axis A is oriented in a direction generally perpendicular to the side members 102a and 102b. The counterweight 338 causes the unloaded panel arm assembly 16 to rotate about the pivot axis A in a counterclockwise direction (as viewed from FIG. 16) into contact with the flange 209 on the column member 200 via an intermediate cross member 304c of the panel arm assembly, such that the forward end of the panel arm assembly 16 corresponding to the forward end cross member 304b is located higher than the rear end of the panel arm assembly 16 corresponding to the rear end cross member 304a (as shown in FIG. 16). The foot subassembly 314 is locked against rotation in a vertical position relative to the support beams 302a and 302b of the panel arm assembly 16 using the foot lock pin 328 as described above.

With the unloaded panel arm assembly 16 in a loading position as described above, the precast panel P may be positioned above the panel arm assembly 16 in a horizontal orientation. The precast panel P may be positioned spaced-apart from the foot subassembly 314 in a lateral direction X so as to ensure proper loading onto the panel arm assembly 16. When the precast panel P is lowered in the horizontal position into contact with the panel arm assembly 16, the precast panel P initially contacts the forward end of the panel arm assembly 16 proximal foot subassembly 314. As a result, because only an edge portion of the precast panel P is in contact with the panel arm assembly 16, friction between the precast panel P and the panel arm assembly 16 can be minimized and the precast panel P may be moved laterally into contact with the foot subassembly 314 more easily. Once the precast panel P is moved laterally into contact with the foot subassembly 314, the precast panel P may be lowered further to push down on the forward end of the panel arm assembly 16, thereby causing the panel arm assembly 16 to rotate about the pivot axis A in a clockwise direction (as viewed from FIG. 16). As the panel arm assembly 16 rotates, it comes into contact with the precast panel P along the entire length of the panel arm assembly 16 extending from the foot subassembly 314 to its rear end. Since, as described above, the panel arm assembly 16 is pivotally coupled to the column assembly 14 off-center, the weight of the precast panel P will cause the loaded panel arm assembly 16 to pivot until it contacts the mounting blocks 140a and 140b of the sliding hook subassemblies 138a and 138b. As a result, the loaded panel arm assembly 16 is brought into a transport position, as shown in FIG. 18, in which the panel arm assembly 16 and the precast panel P are tilted at an angle greater than zero and less than ninety relative to the plane containing the side members 102a and 102b of the lower base subassembly 100 and/or the column member 200 of the column assembly 14. In the transport position, the forward end of the illustrated panel arm assembly 16 corresponding to the forward end cross member 304b (which is proximal foot subassembly 314) may extend past the edge of the trailer bed such that the overall width and height of the load does not exceed federal and/or individual state Department of Transportation limits for oversize loads.

With reference to FIG. 17, the tilt hauling frame 10 may be secured to a flatbed trailer and configured for loading a precast panel P in a vertical position relative to the flatbed trailer as shown. More specifically, in the illustrated embodiment, the lever 124 is in its locked position so that the column assembly 14 is locked against rotation about the rotational axis R relative to the base assembly 12. The unloaded panel arm assembly 16 is oriented generally parallel with the side members 102a and 102b of the lower base subassembly 100 in a direction across the width of the flatbed trailer, and the pivot axis A is oriented in a direction generally perpendicular to the side members 102a and 102b. The unloaded panel arm assembly 16 is rotated about the pivot axis A in a clockwise direction (as viewed from FIG. 17) and is brought into contact with the mounting blocks 140a and 140b. The hook members 144a and 144b of the sliding hook subassemblies 138a and 138b are slid into engagement with the protrusions 336a and 336b to prevent rotation of the unloaded panel arm assembly 16 due to the moment of the counterweight 338. The foot subassembly 314 is rotated into engagement with the stop members 332a and 332b. A jack may be connected at the forward end of the panel arm assembly 16 via one or more attachments plates 350 attached to the forward end cross member 304b so as to stabilize the tilt hauling frame 10 during vertical loading of the precast panel P.

With the unloaded panel arm assembly 16 in a loading position as described above, which is also the transport position, the precast panel P may be positioned above the foot subassembly 314 in a vertical orientation. The precast panel P may be positioned spaced-apart from the foot subassembly 314 in a lateral direction X so as to ensure proper loading onto the panel arm assembly 16. The precast panel P is lowered in the vertical position into contact with the base steel plate 316a of the foot subassembly 314 and then moved laterally into contact with the perpendicular support steel plate 316b of the foot subassembly 314, thereby causing the foot subassembly 314 to act as a hinge for the precast panel P to pivot in a counterclockwise direction (as viewed from FIG. 19) into contact with the panel arm assembly 16. As a result, the loaded panel arm assembly 16 is brought into a transport position, as shown in FIG. 18, in which the panel arm assembly 16 and the precast panel P are tilted at an angle greater than zero and less than ninety relative to the plane containing the side members 102a and 102b of the lower base subassembly 100 and/or the column member 200 of the column assembly 14. The forward end of the illustrated panel arm assembly 16 (which is proximal foot subassembly 314) may extend past the edge of the trailer bed such that the overall width and height of the load does not exceed federal and/or individual state Department of Transportation limits for oversize loads. The foot subassembly 314 may then be locked using the foot lock pin 328 as described above.

With reference to FIG. 19, it is contemplated that the tilt hauling frame 10 may be used without the column spacer 203 for adjusting the height of the column assembly 14 to accommodate different size panels, different height and width load restrictions, and/or different trailer sizes. For example, assuming the panel size and trailer width remain constant, lowering the height of the column assembly 14 can cause the load height to decrease and the load width to increase. Alternatively, assuming the panel size remains constant, lowering the height of the column assembly 14 can compensate for a taller trailer so as to avoid exceeding load height restrictions.

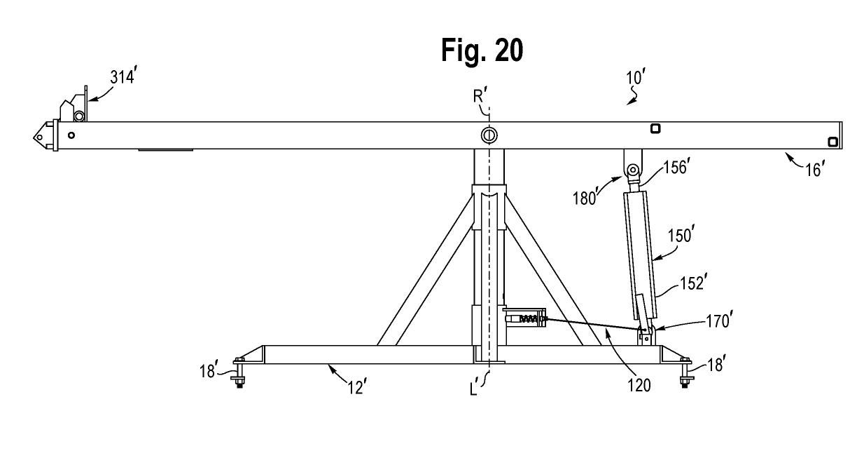

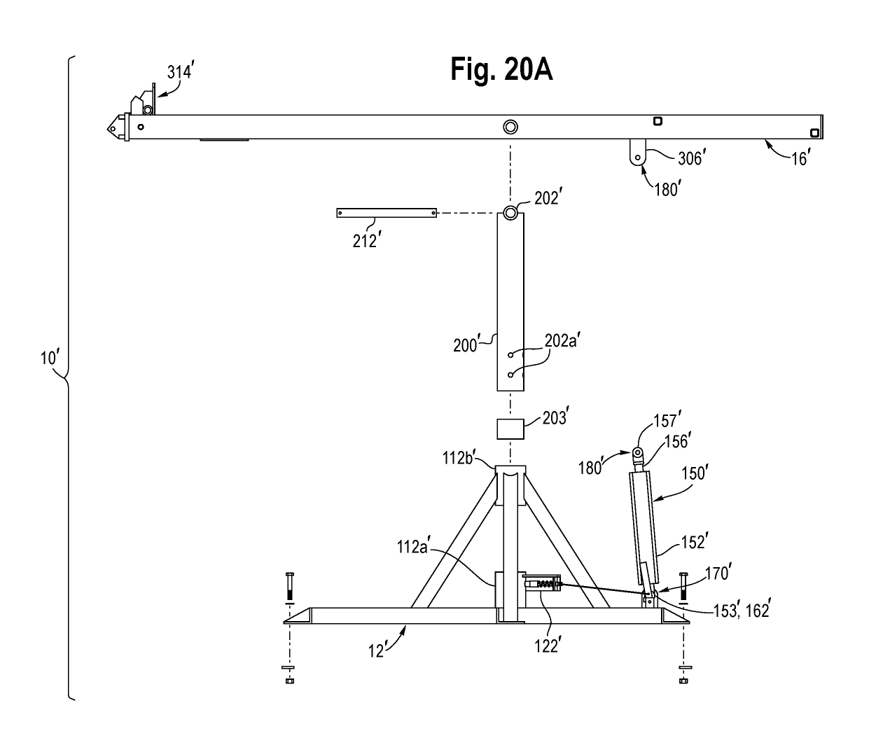

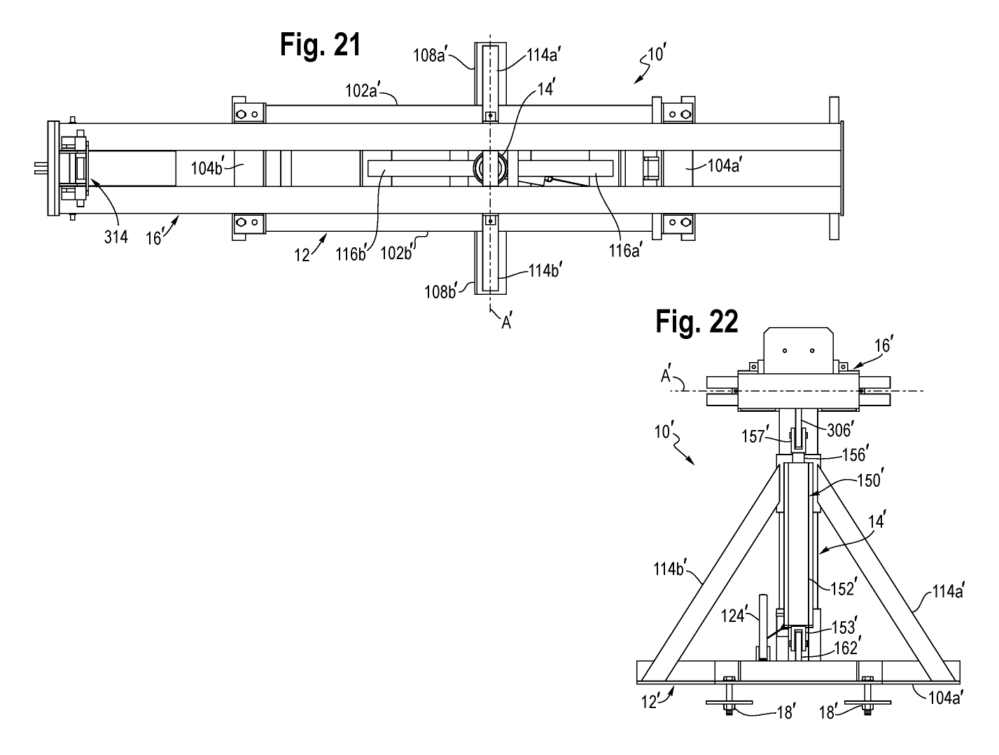

In another embodiment illustrated in FIGS. 20-22, a tilt hauling frame 10′ may include a linear actuator or hydraulic cylinder 150′ for positioning a panel arm assembly 16′ relative to a base assembly 12′ of the tilt hauling frame, as described in more detail below. Alternatively, other types of actuators 150′, including pneumatic actuators, mechanical actuators, and electrical actuators, may be coupled between the panel arm assembly 16′ and base assembly 12′ for positioning a panel arm assembly 16′. Components of the tilt hauling frame 10′ that are similar to those of the tilt hauling frame 10 (FIGS. 1-19) are designated with like reference numerals and a duplicate description is omitted here.

In the embodiment of FIGS. 20-22, the panel arm assembly 16′ is pivotally coupled to a column assembly 14′ about a pivot axis A′ and the column assembly 14′ is rotationally coupled to the base assembly 12′ about a rotational axis R′. Similar to the previously described embodiments, the pivot axis A′ may be oriented perpendicular and the rotational axis R′ may be oriented parallel to the longitudinal axis L′ of a column member 200′ of the column assembly 14′. One or more tilt hauling frames 10′ may be mounted on a transport vehicle, for example a flatbed semitrailer, for hauling a precast panel P that is supported by the respective panel arm assemblies 16′ of the tilt hauling frames 10′. For example, a pair of tilt hauling frames 10′ may be mounted on a flatbed trailer for hauling a precast panel P that is supported at opposite ends thereof by the respective panel arm assemblies 16′ of the pair of tilt hauling frames 10′.

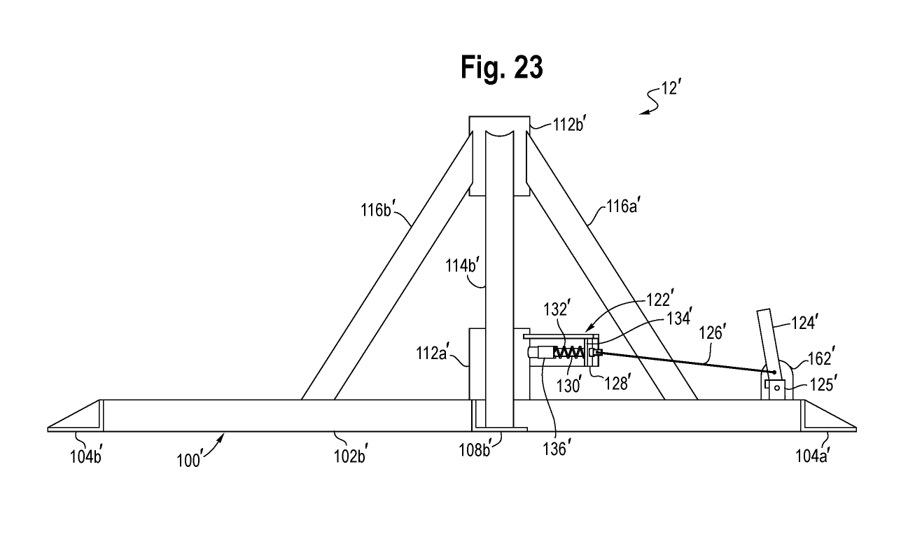

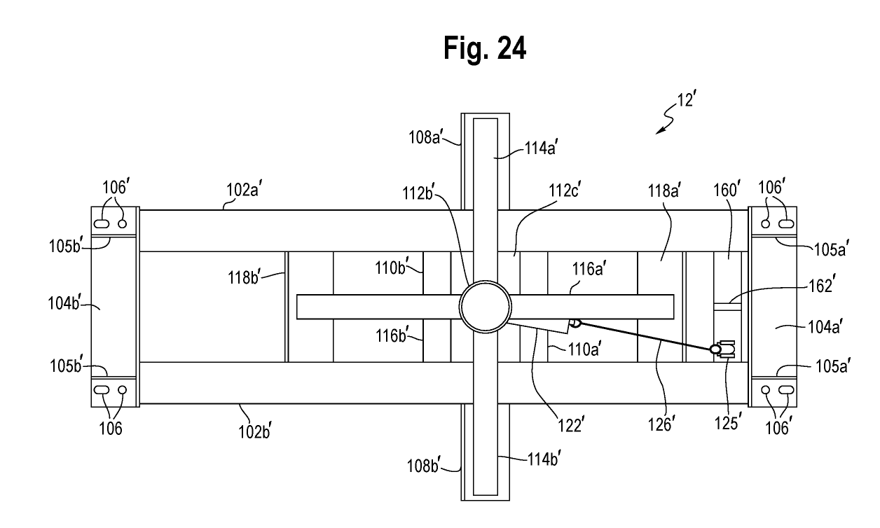

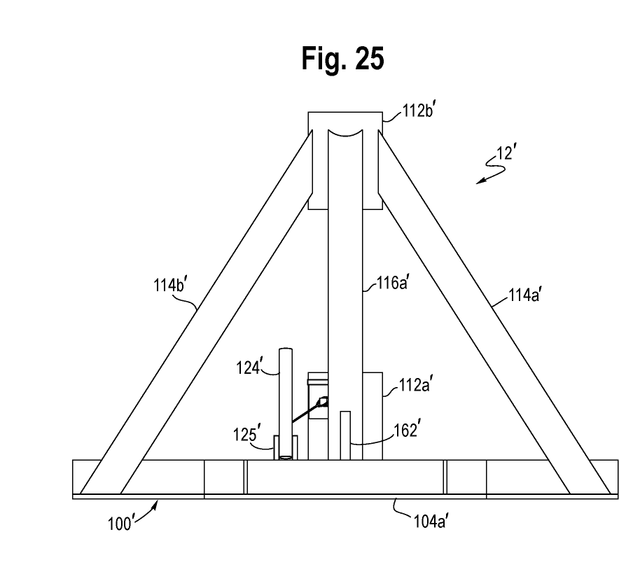

With reference to FIGS. 23-25, a lower base subassembly 100′ of the base assembly 12′ includes oppositely facing side members 102a′ and 102b′ connected between oppositely facing transverse end members 104a′ and 104b′ that define mounting holes 106′ for passing anchor bolts 18′ to secure the base assembly 12′ to the flatbed trailer, similar to the previously described embodiments. The end members 104a′ and 104b′ may be L-shaped brackets, including one or more reinforcement ribs 105a′ and 105b′, respectively, connected between the base leg and the mounting leg of the L-shaped brackets to increase the strength and rigidity of the end members 104a and 104b. The lower base subassembly 100′ also includes a pair of outer transverse bracing members 108a′ and 108b′ attached perpendicularly at one end thereof to the side members 102a′ and 102b′, respectively, between the first end member 104a′ and the midpoint of the side members 102a′ and 102b′. In this example, the outer transverse bracing members 108a′ and 108b′ are illustrated as L-shaped brackets, for example, ASTM structural steel angles, having a base leg or plate and a perpendicular support leg or plate. However, it is also contemplated that other steel shapes, including, but not limited to, steel tube, channels and wide flange beams, and/or other alloys or materials of adequate strength may be used.

In the present example, the lower base subassembly 100′ further includes a pair of inner transverse bracing members 110a′ and 110b′ instead of a single inner transverse bracing member 110 shown in FIG. 5. The inner transverse bracing members 110a′ and 110b′ are connected between the side members 102a′ and 102b′ adjacent to and on opposite sides of a lower sleeve 112a′ (described in further detail below). The inner transverse bracing members 110a′ and 110b′ may be steel tubing, for example, ASTM cold-formed carbon steel tube in a square or rectangular shape, although other steel shapes, including, but not limited to, channels and wide flange beams, and/or other alloys or materials of adequate strength may be used.

The lower base subassembly 100′ may also include a pair of inwardly facing central brackets 118a′ and 118b′ instead of a single outwardly facing central bracket 118 shown in FIG. 5. Each of central bracket 118a′ and 118b′ may be a L-shaped bracket, for example, an ASTM structural steel angle having a base leg or plate and a perpendicular support leg or plate. In the present example, the first central bracket 118a′ is connected between the side members 102a and 102b at a location between the first end member 104a′ and the first inner transverse bracing member 110a′ and the second central bracket 118b′ is connected between the side members 102a and 102b at a location between the second end member 104b′ and the second inner transverse bracing member 110b′.

The base assembly 12′ may also include a sleeve subassembly 112′ having a pair of sleeves 112a′ and 112b′ for supporting the column assembly 14′, similar to the previously described embodiments. The lower sleeve 112a′ may be attached perpendicularly at one end thereof to a mounting plate 112c′. In the present example, the mounting plate 112c′ may be a rectangular steel plate that is fixedly attached, for example, by welding, at opposite sides thereof to the inner transverse bracing members 110a′ and 110b′. Additionally, or alternatively, the mounting plate 112c′ may be fixedly attached, for example, by welding, at opposite sides thereof to the side members 102a′ and 102b′. The bottom surface of the mounting plate 112c′ facing the trailer bed is generally co-planar with the bottom surfaces of the support legs or plates of the central brackets 118a′ and 118b′, the bottom surfaces of the support legs or plates of the end members 104a′ and 104b′, and the bottom surfaces of the inner transverse bracing members 110a′ and 110b′ and the side members 102a′ and 102b′.

In addition, the base assembly 12′ may include a pair of lateral support arms 114a′ and 114b′ and a pair of central support arms 116a′ and 116b′, similar to the previously described embodiments. In the present example, the first lateral support arm 114a′ is connected between the support leg or plate of the first outer transverse bracing member 108a′ at an end portion thereof and the upper sleeve 112b′, and the second lateral support arm 114b′ is connected between the support leg or plate of the second outer transverse bracing member 108b′ at an end portion thereof and the upper sleeve 112b′. Also, the first central support arm 116a′ is connected between the support leg or plate of the first central bracket 118a′ at about the midpoint thereof and the upper sleeve 112b′, and the second central support arm 116b′ is connected the support leg or plate of the second central bracket 118b′ at about the midpoint thereof and the upper sleeve 112b′.

Further, the base assembly 12′ may include a support arm 160′ connected between the side members 102a′ and 102b′ for supporting the hydraulic cylinder 150′. In the present example, the support arm 160′ is located between the first central bracket 118a′ and the first end member 104a′. The support arm 160′ may be steel tubing, for example, ASTM cold-formed carbon steel tube in a square or rectangular shape. However, it is also contemplated that other steel shapes, including, but not limited to, channels and wide flange beams, and/or other alloys or materials of adequate strength may be used.

With reference again to FIGS. 20-22, the hydraulic cylinder 150′ may have a conventional design including a cylinder barrel 152′, a sliding piston (not shown) that reciprocates inside the cylinder barrel 152′, and a piston rod 156′ that is attached to the sliding piston and extends from the cylinder barrel 152′ for transferring power from the piston. For example, the hydraulic cylinder may be a Delavan PML 4024-2004 Hydraulic Cylinder, manufactured by Delavan Pumps, Inc. (Minneapolis, Minn.). The cylinder barrel 152′ may be pivotally coupled at one end thereof to the support arm 160′ of the base assembly 12′ via a cylinder-end hinge joint 170′ having, for example, an axis of rotation parallel to the pivot axis A of the panel arm assembly 16′. In the present example, the cylinder-end hinge joint 170′ includes a steel plate or cylinder mount 162′ attached to the support arm 160′ at about the midpoint of the support arm and a cylinder-end clevis 153′ at the end of the cylinder barrel 152′ that is pivotally mounted on the cylinder mount 162′.

Similarly, the external end of the piston rod 156′ may be pivotally coupled to the panel arm assembly 16′ via a rod-end hinge joint 180′ having, for example, an axis of rotation parallel to the pivot axis A of the panel arm assembly 16′. In the present example, the rod-end hinge joint 180′ includes a steel plate or rod mount 306′, which is attached to the intermediate cross members 304c′ of the panel arm assembly 16′ proximate the rear end cross member 304a′, and a rod-end clevis 157′ at the external end of the piston rod 156′ that is pivotally mounted on the rod mount 306′. The rod-end clevis 157′ includes a removable clevis pin to allow a user to manually engage and disengage the external end of the piston rod 156′ and the rod mount 306′, as further described below. A manual or electric hydraulic pump (not shown) delivers pressurized hydraulic fluid to the hydraulic cylinder 150′ to actuate the piston rod 156′ so as to rotate the panel arm assembly 16′ between different positions for loading, unloading and transporting a precast panel P.

With reference again to FIGS. 23-25, the base assembly 12′ may also include a column locking subassembly 120′ configured to releasably lock the column assembly 14′ against rotation relative to the base assembly 12′, for example when the external end of the piston rod 156′ is disengaged from the rod mount 306′ of the panel arm assembly 16′. The column locking subassembly 120 comprises a spring loaded mechanism 122′, including a housing 128′, a column locking pin 130′, a compression spring 132′, a retaining member 134′, and a collar 136′, that is operatively coupled to a lever 124′ via a cable 126′, similar to the previously described embodiments. In the present example, however, the lever 124′ is pivotally coupled to the support arm 160′ for movement between a locked position and an unlocked position. In particular, the lever 124′ may be pivotally coupled at one end thereof between a pair of oppositely facing ears of a hinge joint 125′ attached to the support arm 160′. In the present example, the hinge joint 125′ is located off-center relative the center length of the support arm 160′ proximate one of the side members 102a′ and 102b′. The lever 124′ may also be coupled, for example at about its midpoint, to the distal end of the column locking pin 130′ via the cable 126′.

With reference again to FIGS. 20-22, the column assembly 14′ may include a tubular hinge joint 202′ pivotally attached proximate an upper end of a column member 200′ so as to pivot about the pivot axis A′ perpendicular to the longitudinal axis of the column member 200′, similar to the previously described embodiments. The lower end of the column member 200′ is rotatably received in the lower sleeve 112a′ and is supported by the mounting plate 112c′, while an intermediate portion of the column member 200′ between the upper and lower ends is rotatably received in the upper sleeve 112b′. A lower portion of the illustrated column member 200′ proximal its lower end defines an opening 200a′ in the wall of the column member 200′ to allow the column locking subassembly 120′ to lock the column assembly 14′ against rotation relative to the base assembly 12′, similar to the previously described embodiments. Also, a column spacer 203′ may be disposed in the lower sleeve 112a′ between the mounting plate 112c′ and the column member 200′ for adjusting the height of the column assembly 14′.

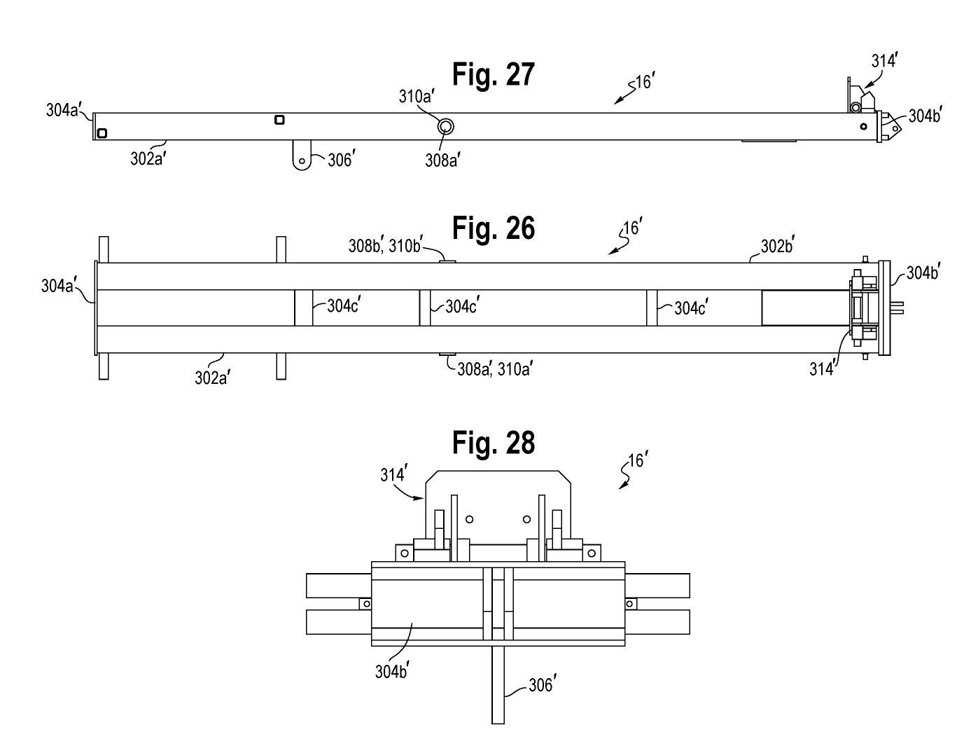

With reference to FIGS. 26-28, similar to the previously described embodiments, the panel arm assembly 16′ may include a pair of generally parallel, spaced-apart oppositely facing support beams 302a′ and 302b′ connected between a pair of spaced-apart oppositely facing transverse rear and forward end cross members 304a′ and 304b′ and one or more intermediate cross members 304c. The tubular hinge joint 202′ is received between the support beams 302a′ and 302b′ and is axially aligned with pivot openings 308a′ and 308b′ formed therein. An arm linchpin 212′ extends through the hinge joint 202′ and the bushings 310a′ and 310b′ in the pivot openings 308a′ and 308b′ so as to pivotally couple the panel arm assembly 16′ to the column assembly 14′ off-center along a length of the panel arm assembly. In addition, the panel arm assembly 16′ may be operably coupled to a foot subassembly 314′ proximal the forward end cross member 304b′, similar to the previously described embodiments.

The precast panel P may be loaded onto the tilt hauling frame 10′, for example, in a horizontal orientation. More specifically, when the lever 124′ is in its locked position and/or the piston rod 156′ of the hydraulic cylinder 150′ is engaged with the rod mount 306′ of the panel arm assembly 16′, the unloaded panel arm assembly 16′ is oriented generally parallel with the side members 102a′ and 102b′ of the lower base subassembly 100′ in a direction across the width of the flatbed trailer, and the pivot axis A′ is oriented in a direction generally perpendicular to the side members 102a′ and 102b′. The hydraulic cylinder 150′ may be actuated (using the hydraulic pump) to extend the piston rod 156′ so as to cause the unloaded panel arm assembly 16′ to rotate about the pivot axis A′ into a horizontal position in which the panel arm assembly 16′ is oriented generally parallel with the side members 102a′ and 102b′ of the lower base subassembly 100′ in a direction across the length of the flatbed trailer. The foot subassembly 314 is locked against rotation in a vertical position relative to the support beams 302a and 302b of the panel arm assembly 16′, similar to the previously described embodiments.

With the unloaded panel arm assembly 16′ in a horizontal loading position as described above, the precast panel P may be positioned above the panel arm assembly 16′ in a horizontal orientation. The precast panel P may be positioned spaced-apart from the foot subassembly 314′ in a lateral direction and lowered in the horizontal position into contact with the panel arm assembly 16′. Then, the precast panel P may be moved laterally into contact with the foot subassembly 314′. Thereafter, the hydraulic cylinder 150′ may be actuated (using the hydraulic pump) to retract the piston rod 156′ so as to cause the loaded panel arm assembly 16′ to rotate about the pivot axis A′ into a desired transport position. For example, the hydraulic cylinder 150′ may rotate the loaded panel arm assembly 16′ until the loaded panel arm assembly 16′ contacts the end member 104b′ of the base assembly 12′. As a result, the loaded panel arm assembly 16′ is brought into a transport position, in which the panel arm assembly 16′ and the precast panel P are tilted at an angle greater than zero and less than ninety relative to the plane containing the side members 102a′ and 102b′ of the lower base subassembly 100′ and/or the column member 200′ of the column assembly 14′. In the transport position, the forward end of the illustrated panel arm assembly 16′ corresponding to the forward end cross member 304b′ (which is proximal foot subassembly 314′) may extend past the edge of the trailer bed such that the overall width and height of the load does not exceed federal and/or individual state Department of Transportation limits for oversize loads.

Advantageously, the tilt hauling frame 10 or 10′ of the present disclosure allows precast panels to be easily loaded and transported without exceeding size regulations that would require permits for oversize shipments. That is, by tilting a panel for transport relative to the trailer bed, the tilt hauling frame 10 or 10′ can provide a smaller footprint across the width or height of the load as desired. More specifically, the tilt hauling frame 10 or 10′ allows a precast panel to be transported with reduced restrictions by positioning the precast panel so that it does not exceed federal and individual state Department of Transportation limits on the height and width of loads transported over public roads. As a result, transportation costs can be reduced by eliminating or reducing permit and escort vehicle costs that would otherwise be required for transporting a precast panel as an oversize load in a typical configuration, for example laying flat on the trailer bed or positioned perpendicular to the trailer bed.

By mounting the panel arm assembly to the column assembly off-center along a length of the panel arm assembly, the tilt hauling frame 10 or 10′ of the present disclosure also allows a precast panel to be positioned for transport such that the precast panel's center of mass is located directly above the center of mass of the trailer. This maintains a balanced load on the trailer wheels despite the skewed position of the panel relative to the trailer deck, avoiding a condition that would otherwise make the trailer susceptible to tipping during transport.

The tilt hauling frame 10 or 10′ of the present disclosure is also reconfigurable, via the addition or removal of the column spacer 203 or 203′, to meet different cargo height and width restrictions, which vary by jurisdiction. This enables a single frame design to be used in multiple states, saving the cost of acquisition and storage of multiple frame designs.

In an unloaded state, the tilt hauling frame 10 or 10′ of the present disclosure can be reconfigured easily by a user. For example, the tilt hauling frame 10 can be reconfigured from the ground using the column rotator subassembly 204, as described above. In particular, when the lever 124 is in its unlocked position and the column locking pin 130 is disengaged with the column member 200, the user can rotate the rod 206 about the longitudinal axis L of a column member 200, thereby rotating the column assembly 14 relative to the base assembly 12 until, for example, the panel arm assembly 16 is oriented in a direction parallel to the length of the trailer. Similarly, the tilt hauling frame 10′ can be reconfigured into a stowed position by disengaging the piston rod 156′ of the hydraulic cylinder 150′ from the rod mount 306′ of the panel arm assembly 16′ and bringing the lever 124′ into its unlocked position so as to allow the column assembly 14′ to rotate about the rotational axis R′ relative to the base assembly 12′. Thereafter, the user can rotate the panel arm assembly 16′, which is coupled to the upper end of the column member 200′, relative to the base assembly 12′ such that panel arm assembly 16′is oriented along the length of the trailer bed. This allows that tilt hauling frame 10 or 10′ to be transported without restrictions on the trailer, avoiding any costs that may be required if the panel arm assembly 16 or 16′ extended beyond the edges of the trailer.

The tilt hauling frame 10 or 10′ of the present disclosure mounting may be compatible with all standard North American flatbed trailer configurations. This avoids the cost of acquiring and storing multiple frame designs to match different trailers, which may be used to transport other cargo besides precast panels.

The tilt hauling frame 10 or 10′ of the present disclosure enables a single frame design to be used for loading precast panels in a horizontal or vertical position. Whether a crane picks up a panel from the panel's narrow face or its wide face is determined by the intended use/function of the panel. As a result, the tile hauling frame 10 or 10′ avoids the cost of acquiring and storing multiple frame designs to support different precast panel loading configurations.

Thus, the invention provides, among other things, a tilt hauling frame. Various features and advantages of the invention are set forth in the following claims.

What is claimed is:

1. A tilt hauling frame comprising:
a base assembly configured to mount onto a trailer bed;
a column assembly supported by the base assembly at a first end of the column assembly; and
a panel arm assembly pivotally coupled proximate to a second end of the column assembly.

2. The tilt hauling frame of claim 1, wherein the panel arm assembly is pivotally coupled proximate to the second end of the column assembly at a location on the panel arm assembly that is off-center along a length of the panel arm assembly.

3. The tilt hauling frame of claim 1 further comprising an actuator connected between the panel arm assembly and the base assembly for positioning the panel arm assembly relative to the base assembly.

4. The tilt hauling frame of claim 3, wherein the actuator is a hydraulic actuator that is pivotally connected at one end to the panel arm assembly and is pivotally connected at an opposite end to the base assembly.

5. The tilt hauling frame of claim 1, wherein the panel arm assembly includes a counterweight attached to an end of the panel arm assembly for positioning the panel arm assembly relative to a base assembly.

6. The tilt hauling frame of claim 1, wherein the panel arm assembly is pivotally coupled to the column assembly about a pivot axis oriented perpendicular to a longitudinal axis of the column assembly.

7. The tilt hauling frame of claim 1, wherein the panel arm assembly includes a foot subassembly having a bracket rotatably mounted at one end of the panel arm assembly.

8. The tilt hauling frame of claim 1, wherein the column assembly is rotationally coupled to the base assembly about a rotational axis oriented substantially parallel to a longitudinal axis of the column assembly.

9. The tilt hauling frame of claim 1,
wherein the base assembly includes a lower base subassembly configured to mount onto the trailer bed, a first sleeve attached perpendicularly to the lower base subassembly, a second sleeve disposed co-axially with the first sleeve above the first sleeve relative to the lower base subassembly, and a plurality of support arms connected between the second sleeve and lower base subassembly, and
wherein the column assembly includes a column member having a lower end received in the first sleeve, an upper end opposite the lower end, and an intermediate portion disposed between the upper end and the lower end and received in the second sleeve,
wherein the column assembly is rotationally coupled to the base assembly about a rotational axis oriented substantially parallel to a longitudinal axis of the column member.

10. The tilt hauling frame of claim 9, wherein the base assembly includes a column locking subassembly configured to releasably lock the column assembly against rotation relative to the base assembly, including a spring loaded mechanism mounted over an opening in a wall of the first sleeve and operatively coupled to a pivotable lever mounted on the lower base subassembly via a cable.

11. A tilt hauling frame comprising:
a base assembly;
a column assembly rotationally coupled to the base assembly about a rotational axis co-axial with a longitudinal axis of the column assembly; and
a panel arm assembly pivotally coupled to the column assembly about a pivot axis oriented perpendicular to the longitudinal axis of the column assembly.

12. The tilt hauling frame of claim 11, wherein the panel arm assembly is pivotally coupled proximate to one end of the column assembly at a location on the panel arm assembly that is off-center along a length of the panel arm assembly.

13. The tilt hauling frame of claim 12 further comprising an actuator connected between the panel arm assembly and the base assembly for positioning the panel arm assembly relative to the base assembly.

14. The tilt hauling frame of claim 13, wherein the actuator is a hydraulic actuator that is pivotally connected at one end to the panel arm assembly and is pivotally connected at an opposite end to the base assembly.

15. The tilt hauling frame of claim 14, wherein the panel arm assembly includes a counterweight attached to an end of the panel arm assembly for positioning the panel arm assembly relative to a base assembly.

16. The tilt hauling frame of claim 15, wherein the panel arm assembly includes a foot subassembly having a bracket rotatably mounted at one end of the panel arm assembly.

17. A tilt hauling frame comprising:
a base assembly including
a lower base subassembly configured to mount onto a trailer bed,
a first sleeve attached perpendicularly to the lower base subassembly,
a second sleeve disposed co-axially with the first sleeve above the first sleeve relative to the lower base subassembly, and
a plurality of support arms connected between the second sleeve and lower base subassembly;
a column assembly supported by the base assembly, the column assembly including
a column member having a lower end received in the first sleeve, an upper end opposite the lower end, and an intermediate portion disposed between the upper end and the lower end and received in the second sleeve,
a hinge joint attached to the upper end of the column member, the hinge joint having a pivot axis perpendicular to a longitudinal axis of the column member; and
a panel arm assembly pivotally coupled to the column assembly via the hinge joint and configured to support a load in a transport position when the panel arm assembly is oriented in a direction across a width of the trailer bed and is tilted relative to the trailer bed into contact with the base assembly.

18. The tilt hauling frame of claim 17 further comprising a hydraulic actuator that is pivotally connected at one end to the panel arm assembly and is pivotally connected at an opposite end to the base assembly for positioning the panel arm assembly.
